(19) United States
(12) Patent Application Publication
(10) Pub. No.: US 2023/0306433 A1
(43) Pub. Date: Sep. 28, 2023

(54) Cognitive Identification of Credit Reporting Disputes and Dispute Resolution Using Quantum Computing

(71) Applicant: Bank of America Corporation, Charlotte, NC (US)

(72) Inventors: Gaurav Dadhich, Gurgaon (IN); Abhishek Trivedi, Hyderabad (IN); Prashant Khare, Maharashtra (IN); Chandrashekar Sairam, Hyderabad (IN); Shruti Nandini Thakur, Hyderabad (IN); Rathna Prabha Kandepu, Hyderabad (IN)

(21) Appl. No.: 17/703,492

(22) Filed: Mar. 24, 2022

(51) Int. Cl. G06Q 20/40; G06Q 40/02; G06N 10/60

(52) U.S. Cl. CPC G06Q 20/4037; G06Q 40/025; G06N 10/60; G06Q 2220/00

(57) ABSTRACT

Aspects of the disclosure relate to cognitive identification of credit reporting disputes and dispute resolution using quantum computing. A computing platform may retrieve, using a quantum computing device, dispute data from a block chain of dispute requests. The computing platform may convert the dispute data into quantum bits. The computing platform may perform quantum searching of the retrieved dispute data over a plurality of different databases and identify potential dispute transactions. The computing platform may determine probability scores for the potential dispute transactions, each probability score being based on a likelihood that a change associated with the potential dispute transactions is to be made. The computing platform may determine respective parameters associated with the potential dispute transactions, wherein each parameter indicates a type of change to be made. The computing platform may apply a change associated with the potential dispute transactions and add a new block to the block chain.

### BACKGROUND

Aspects of the disclosure generally relate to one or more computer systems, servers, and/or other devices including hardware and/or software. In particular, one or more aspects of the disclosure relate to cognitive identification of credit reporting disputes and dispute resolution using quantum computing.

The credit report dispute process is designed to help customers ensure the accuracy of their credit reports. In a typical process, a customer would review their credit reports on a regular basis in order to identify reporting inaccuracies and raise credit reporting disputes separately with each individual credit reporting agency and/or financial institution, among other manual steps. This process is often cumbersome, inefficient, and resource intensive. In some cases, financial institutions may receive duplicate disputes for investigation (e.g., customers sending separate disputes to each of several bureaus that creditors report to). In many instances, it might be determined that the information disputed on the credit report is accurate and no changes need to be made, resulting in non-value add processing. Due to these and other factors, the time frame for obtaining a resolution of credit reporting errors is often longer than desired. In many instances, it may be difficult to utilize current credit reporting dispute mechanisms to efficiently and accurately resolve credit reporting disputes.

### SUMMARY

Aspects of the disclosure provide effective, efficient, scalable, and convenient technical solutions that address and overcome the technical problems associated with cognitive identification of credit reporting disputes and dispute resolution using quantum computing. In accordance with one or more embodiments, a computing platform (e.g., a quantum computing platform using a quantum computing device) having at least one processor, a communication interface, and memory may retrieve, via the communication interface, dispute data from a block chain of dispute requests. The computing platform may convert the retrieved dispute data into quantum bits for quantum searching. The computing platform may perform, using quantum logic gates, quantum searching of the retrieved dispute data over a plurality of different databases. The computing platform may identify, based on the quantum searching, one or more potential dispute transactions. The computing platform may determine, using the quantum computing device, probability scores for the one or more potential dispute transactions, each probability score being based on a likelihood that a change associated with the one or more potential dispute transactions is to be made. The computing platform may determine respective parameters associated with the one or more potential dispute transactions. In addition, each parameter may indicate a type of change to be made. The computing platform may, based on determining the probability scores and the respective parameters, apply a change associated with the one or more potential dispute transactions. The computing platform may add a new block to the block chain of dispute requests.

In some embodiments, the computing platform may receive user provided credit information and validate the user provided credit information.

In some arrangements, the computing platform may prioritize the one or more potential dispute transactions in a queue based on the probability score for the one or more potential dispute transactions. In some example arrangements, the one or more potential dispute transactions in the queue is further prioritized based on a remaining turnaround time.

In some embodiments, the quantum searching may be implemented using a plurality of quantum logic gates. In some examples, the plurality of logic gates may include a conservative logic gate and a fundamental quantum gate. In some examples, the quantum searching may be further implemented using a refinement logic gate.

In some embodiments, each block of the block chain may include a cryptographic hash of a corresponding dispute request. In some embodiments, each block of the block chain may include a cryptographic hash of a user identifier.

In some examples, the quantum computing device may engage at least one of a plurality of quantum bots, each bot being configured to perform a different type of functionality.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1C depict an illustrative computing environment for cognitive identification of credit reporting disputes and dispute resolution using quantum computing in accordance with one or more example embodiments;

FIGS. 2A-2D depict an illustrative event sequence for cognitive identification of credit reporting disputes and dispute resolution using quantum computing in accordance with one or more example embodiments;

FIGS. 3A-3C depict another illustrative event sequence for cognitive identification of credit reporting disputes and dispute resolution using quantum computing in accordance with one or more example embodiments;

FIGS. 4 and 5 depict illustrative graphical user interfaces associated with cognitive identification of credit reporting disputes and dispute resolution using quantum computing in accordance with one or more example embodiments;

FIG. 6 depicts an illustrative block chain associated with cognitive identification of credit reporting disputes and dispute resolution using quantum computing in accordance with one or more example embodiments;

FIG. 7 depicts an illustrative method for using a DNA computing engine for cognitive identification of credit reporting disputes and dispute resolution in accordance with one or more example embodiments; and

FIG. 8 depicts an illustrative method for using quantum bots (quantum computing bots, also referred to as Qbots) and quantum logic gates to identify transactions for deferral in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to cognitive identification of credit reporting disputes and dispute resolution using quantum computing. In particular, one or more aspects of the disclosure may employ DNA and quantum computing techniques to automatically identify and raise credit reporting disputes. Additional aspects of the disclosure may use retrieval chatbots (bots) to extract block data from a block chain to create credit reporting dispute cases. Additional aspects of the disclosure may employ quantum bots (Qbots) to perform quantum searching using quantum logic gates and refinement gates in resolving disputes and/or taking other appropriate actions. Further aspects of the disclosure may reduce or avoid duplicate processing of dispute cases. Further aspects of the disclosure may provide a consortium arrangement and an associated application programming interface (API) for facilitating credit reporting dispute resolution where multiple financial institutions share and/or access information with appropriate permissions.

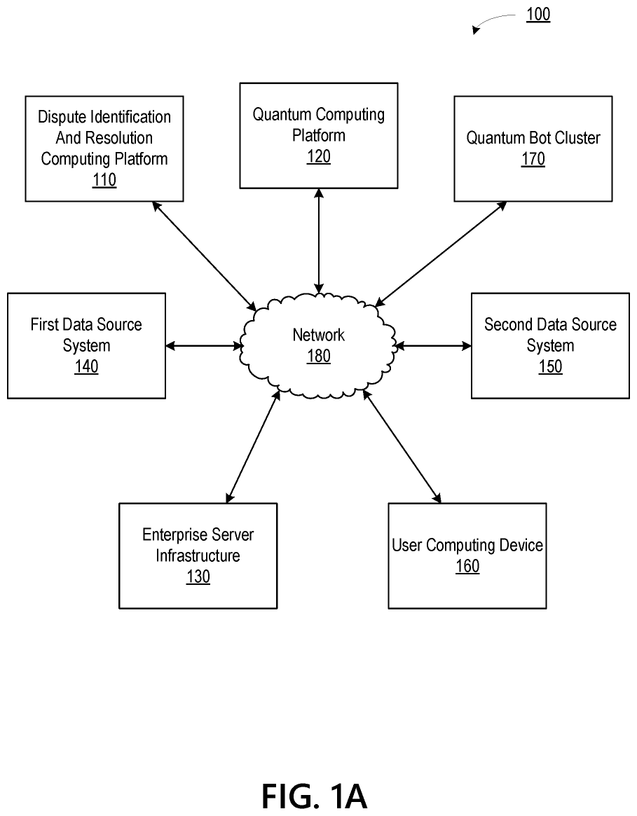

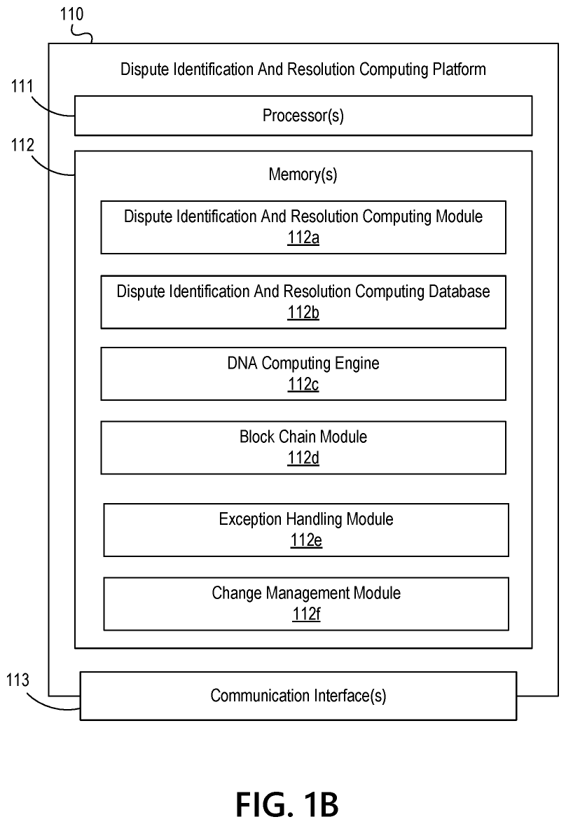

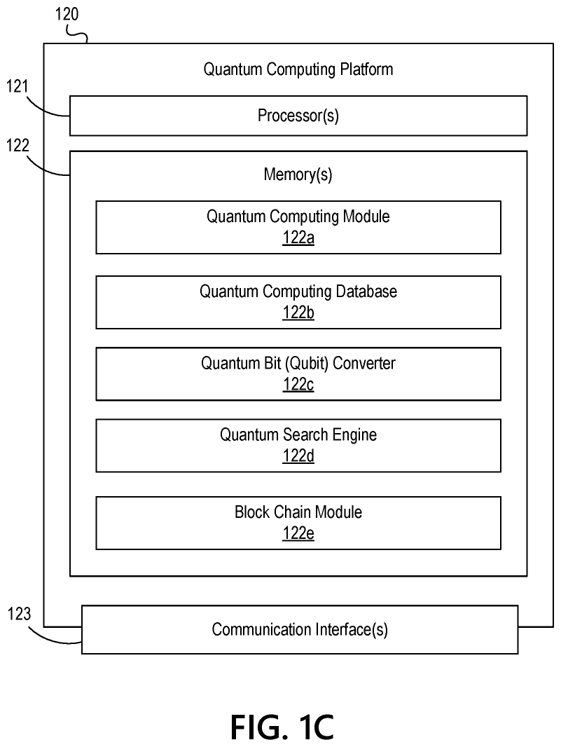

FIGS. 1A-1C depict an illustrative computing environment for cognitive identification of credit reporting disputes and dispute resolution using quantum computing in accordance with one or more example embodiments. Referring to FIG. 1A, computing environment 100 may include one or more computing devices and/or other computing systems. For example, computing environment 100 may include dispute identification and resolution computing platform 110, quantum computing platform 120, enterprise server infrastructure 130, first data source system 140, second data source system 150, user computing device 160, and quantum bot cluster 170.

As illustrated in greater detail below, dispute identification and resolution computing platform 110 may be a computer system that includes one or more computing devices (e.g., servers, server blades, or the like) and/or other computer components (e.g., processors, memories, communication interfaces) configured to perform one or more of the functions described herein. For example, dispute identification and resolution computing platform 110 may include one or more computers that may be used to automatically identify reporting inaccuracies and recommend or otherwise convey information to users for raising disputes on the identified inaccuracies. In some instances, the dispute identification and resolution computing platform 110 may be maintained by an enterprise organization (e.g., a financial institution, or the like) and may be configured to receive historical data (e.g., historical payment data or other relevant historical data), information relating to one or more credit reports (e.g., current credit report data), and/or the like, and detect discrepancies.

Quantum computing platform 120 may be a computer system that includes one or more computing devices (e.g., servers, server blades, or the like) and/or other computer components (e.g., processors, memories, communication interfaces) configured to perform one or more of the functions described herein. For example, quantum computing platform 120 may include one or more computers that may be used to provide high speed computation and execution power to quantum computing bots (Qbots). Quantum computing platform 120 may engage each of a plurality of quantum bots (e.g., a quantum bots (Qbots) cluster 170) to perform a different type of dispute resolution functionality. For example, the quantum computing platform 120 may employ a plurality of quantum bots (e.g., Qbots cluster 170) for executing quantum searching using quantum logic gates. The quantum computer may operate on quantum bits (qubits) of data.

Enterprise server infrastructure 130 may include one or more computing devices and/or other computer components (e.g., processors, memories, communication interfaces). In addition, and as illustrated in greater detail below, enterprise server infrastructure 130 may be configured to host, execute, and/or otherwise provide one or more enterprise applications (e.g., a mobile banking application, and/or the like). Enterprise server infrastructure 130 may also be configured to receive information from, send information to, and/or otherwise exchange information with one or more devices as described herein. The location where enterprise server infrastructure 130 is deployed may be remote from dispute identification and resolution computing platform 110, quantum computing platform 120, first data source system 140, second data source system 150, user device 160, and/or quantum bot cluster 170.

First data source system 140 may, for example, create, store, manipulate, manage, provide access to, and/or otherwise maintain historical credit data of individual users or customers, such as credit data generally collected by a credit bureau (e.g., payment information, credit history, debt-to-income ratio, and/or the like). In some instances, first data source system 140 may be and/or include a data lake. Although one data source system 140 is shown for illustrative purposes, any number of data source systems may be included without departing from the disclosure. For example, there could be three or more data source systems 140 (e.g., one corresponding to each credit reporting agency).

Second data source system 150 may, for example, create, store, manipulate, manage, provide access to, and/or otherwise maintain current credit reports for individual users or customers. In some instances, second data source system 150 may be and/or include a new credit report file. Although one data source system 150 is shown for illustrative purposes, any number of data source systems may be included without departing from the disclosure. For example, there could be three or more data source systems 150 (e.g., one corresponding to each credit reporting agency).

User computing device 160 may include one or more computing devices and/or other computer components (e.g., processors, memories, communication interfaces). For instance, user computing device 160 may be a server, desktop computer, laptop computer, tablet, mobile device, or the like. User computing device 160 may be configured to communicate with and/or connect to one or more computing devices or systems shown in FIG. 1A. For instance, user computing device 160 may communicate with one or more computing systems or devices via network 180. The user computing device may be used to provide access one or more systems, devices, computing platforms, and the like, as well as to display one or more user interfaces, as will be discussed more fully below.

Computing environment 100 also may include one or more networks, which may interconnect one or more of dispute identification and resolution computing platform 110, quantum computing platform 120, enterprise server infrastructure 130, first data source system 140, second data source system 150, user computing device 160, quantum bot cluster 170, or the like. For example, computing environment 100 may include a network 180 (which may interconnect, e.g., dispute identification and resolution computing platform 110, quantum computing platform 120, enterprise server infrastructure 130, first data source system 140, second data source system 150, user computing device 160, quantum bot cluster 170, and/or one or more other systems which may be associated with an enterprise organization, such as a financial institution, with one or more other systems, public networks, sub-networks, and/or the like).

In one or more arrangements, dispute identification and resolution computing platform 110, quantum computing platform 120, enterprise server infrastructure 130, first data source system 140, second data source system 150, and user computing device 160 may be any type of computing device capable of receiving a user interface, receiving input via the user interface, and communicating the received input to one or more other computing devices. For example, dispute identification and resolution computing platform 110, quantum computing platform 120, enterprise server infrastructure 130, first data source system 140, second data source system 150, user computing device 160, quantum bot cluster 170, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions as described herein.

Referring to FIG. 1B, dispute identification and resolution computing platform 110 may include one or more processor(s) 111, memory(s) 112, and communication interface(s) 113. A data bus may interconnect processor 111, memory 112, and communication interface 113. Communication interface 113 may be a network interface configured to support communication between dispute identification and resolution computing platform 110 and one or more networks (e.g., network 180, or the like). Memory 112 may include one or more program modules having instructions that when executed by processor 111 cause dispute identification and resolution computing platform 110 to perform one or more functions described herein and/or one or more databases and/or other libraries that may store and/or otherwise maintain information which may be used by such program modules and/or processor 111.

In some instances, the one or more program modules and/or databases may be stored by and/or maintained in different memory units of dispute identification and resolution computing platform 110 and/or by different computing devices that may form and/or otherwise make up dispute identification and resolution computing platform 110. For example, memory 112 may have, store, and/or include a dispute identification and resolution computing module 112a, a dispute identification and resolution computing database 112b, a DNA computing engine 112c, a block chain module 112d, an exception handling module 112e, and a change management module 112f. Dispute identification and resolution computing module 112a may have instructions that direct and/or cause dispute identification and resolution computing platform 110 to monitor and analyze credit report data, identify reporting inaccuracies, identify and consolidate duplicate dispute requests, generate notifications and/or recommendations, initiate and perform dispute resolution, and/or perform other functions, as discussed in greater detail below. Dispute identification and resolution computing database 112b may store information used by dispute identification and resolution computing module 112a and/or dispute identification and resolution computing platform 110 in cognitive identification of credit reporting disputes and dispute resolution and/or in performing other functions. DNA computing engine 112c may have instructions that direct and/or cause dispute identification and resolution computing platform 110 to set, define, and/or iteratively redefine rules, techniques and/or other parameters used by dispute identification and resolution computing platform 110 and/or other systems in computing environment 100 in performing cognitive identification of credit reporting disputes and dispute resolution. DNA computing engine 112c may allow massive parallel computation, where complex mathematical equations or problems are solved at much less time and require less hardware than the traditional computer.

Dispute identification and resolution computing platform 110 may further have, store and/or include a block chain module 112d. Block chain module 112d may store instructions and/or data that may cause or enable dispute identification and resolution computing platform 110 to write dispute information to a block chain associated with a user. In some examples, data identifying the user may be stored separately from the dispute data. Accordingly, block chain data may be used to identify behaviors, monitor trends, and the like, in anonymous data without a user providing any personal information or personally identifying information. While the term block chain is used, any distributed ledger could be used without departing from the disclosure.

Dispute identification and resolution computing platform 110 may further have, store and/or include an exception handling module 112e and a change management module 112f. Exception handling module 112e may store instructions and/or data that may cause or enable dispute identification and resolution computing platform 110 to identify actions to be taken for individual sets of exceptions and take appropriate actions. In some examples, an actuator may be used to drive the actions. For example, an exception may occur when a bot is unable to process a transaction based on its programed instructions. Change management module 112f may store instructions and/or data that may cause or enable dispute identification and resolution computing platform 110 to identify changes (e.g., in policies, procedures, guidelines, or the like of organizations) and take appropriate actions.

Referring to FIG. 1C, quantum computing platform 120 may include one or more processors 121, memory 122, and communication interface 123. A data bus may interconnect processor 121, memory 122, and communication interface 123. Communication interface 123 may be a network interface configured to support communication between quantum computing platform 120 and one or more networks (e.g., network 180, or the like). Memory 122 may include one or more program modules having instructions that when executed by processor 121 cause quantum computing platform 120 to perform one or more functions described herein and/or one or more databases that may store and/or otherwise maintain information which may be used by such program modules and/or processor 121. In some instances, the one or more program modules and/or databases may be stored by and/or maintained in different memory units of quantum computing platform 120 and/or by different computing devices that may form and/or otherwise make up quantum computing platform 120. For example, memory 122 may have, host, store, and/or include quantum computing module 122a, quantum computing database 122b, quantum bit (qubit) converter 122c, quantum search engine 122d, and block chain module 122e.

Quantum computing module 122a may have instructions that direct and/or cause quantum computing platform 120 to retrieve dispute information from a block chain, identify transactions for dispute resolution, identify parameters for adjustment, queue in cases with a high probability for needing change, extract customer provided credit statements/documents, validate information against a system of records, perform quantum searching, and/or perform other functions, as discussed in greater detail below. Quantum computing database 122b may store information used by quantum computing module 122a and/or quantum computing platform 120 in dispute resolution using quantum computing and/or in performing other functions. Quantum bit converter 122c may be and/or include a binary code translator that converts binary bits into qubits for quantum computing. Quantum search engine 122d may perform quantum searching on databases using quantum logic gates and refinement logic gates. Quantum computing platform 120 may further have, store and/or include a block chain module 122e. Block chain module 122e may store instructions and/or data that may cause or enable quantum computing platform 120 to write dispute information to a block chain associated with a user. In some examples, data identifying the user may be stored separately from the dispute data. Accordingly, block chain data may be used to identify behaviors, monitor trends, and the like, in anonymous data without a user providing any personal information or personally identifying information.

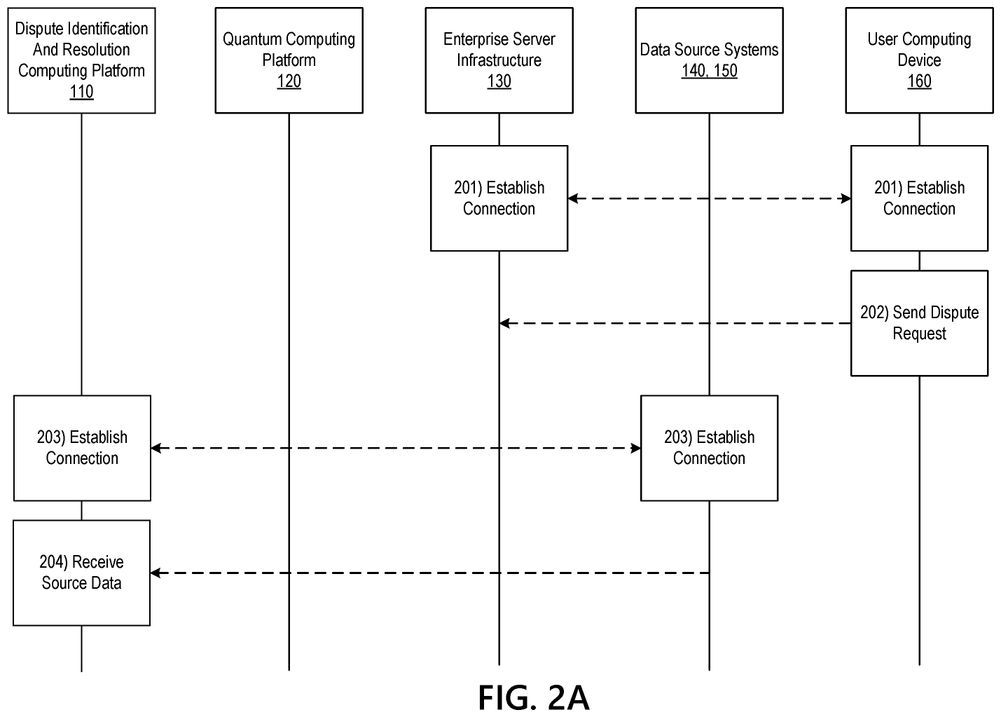

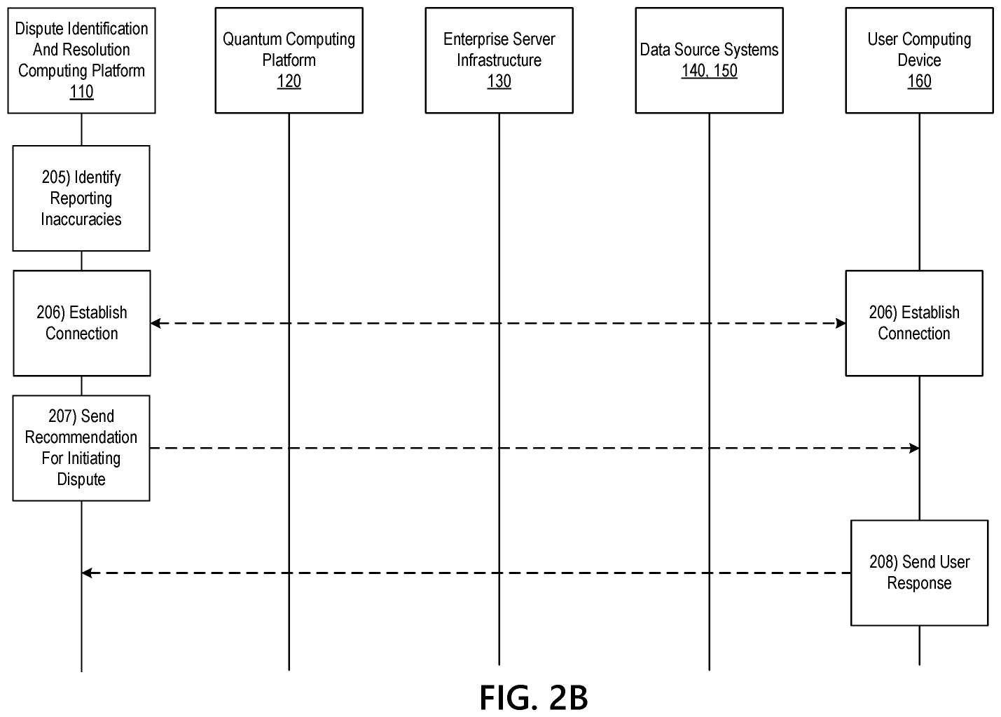

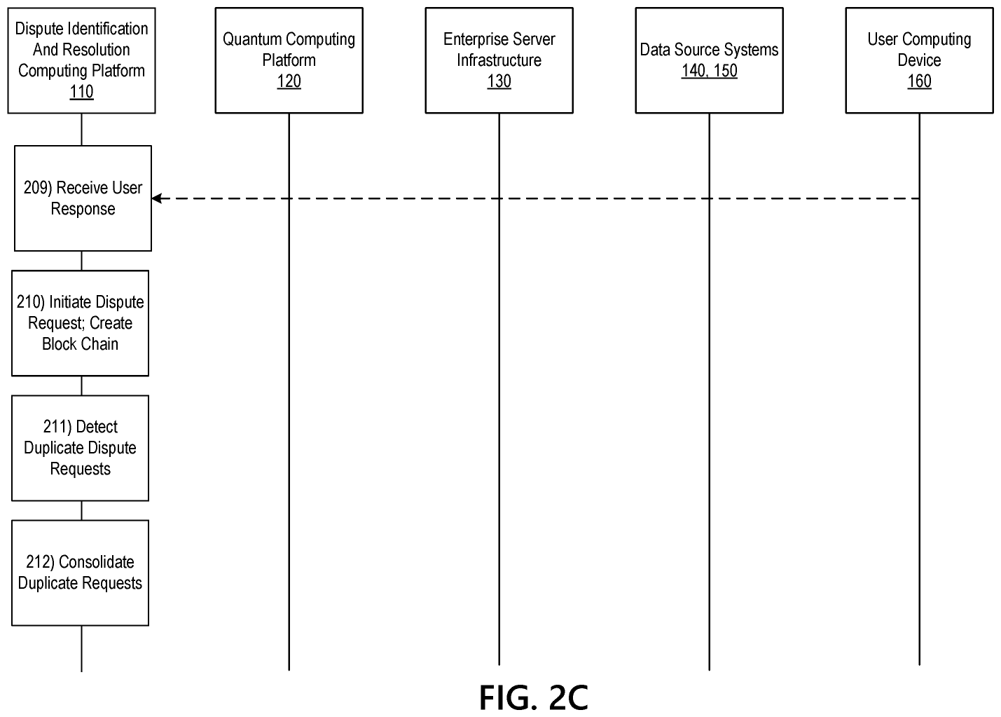

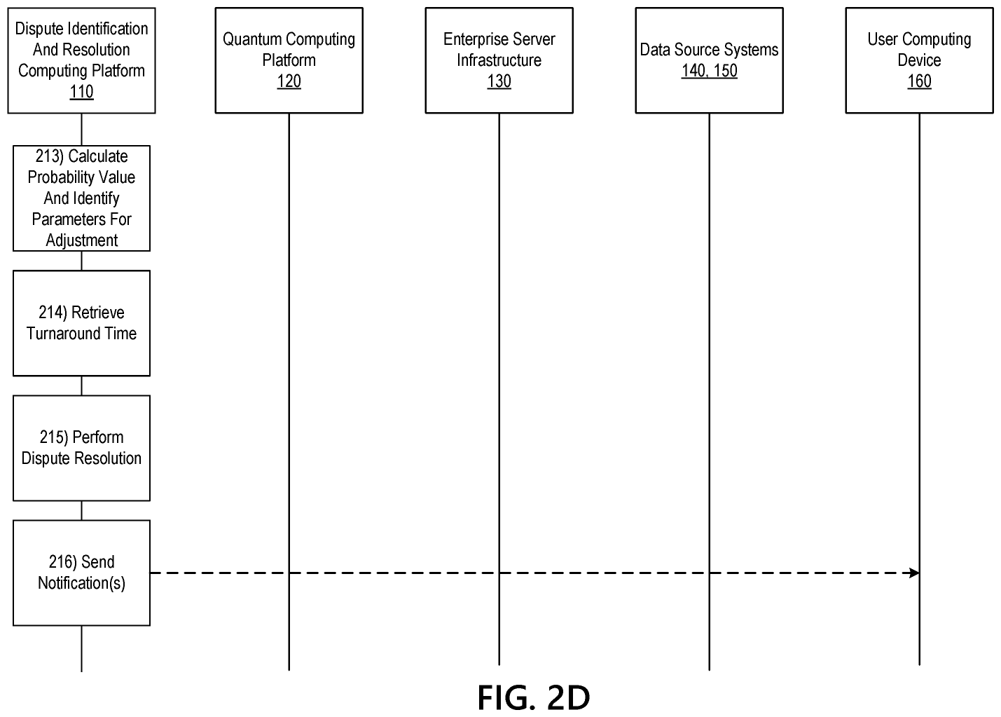

FIGS. 2A-2D depict an illustrative event sequence for cognitive identification of credit reporting disputes and dispute resolution using quantum computing in accordance with one or more example embodiments. Referring to FIG. 2A, at step 201, user computing device 160 may establish a connection with enterprise computing infrastructure 120. For example, user computing device 160 may establish a first wireless data connection with enterprise computing infrastructure 120 to link user computing device 160 with enterprise computing infrastructure 120. In some instances, user computing device 160 may identify whether or not a connection is already established with enterprise computing infrastructure 120. If a connection is already established with enterprise computing infrastructure 120, user computing device 160 might not re-establish the connection. If a connection is not yet established with the enterprise computing infrastructure 120, user computing device 160 may establish the first wireless data connection as described above.

At step 202, user computing device 160 may send, via the communication interface (e.g., communication interface 113) and while the first wireless data connection is established, a dispute request. The dispute request at step 202 may be a dispute that is identified and requested by the user, and/or a dispute that is not identified by dispute identification and resolution computing platform 110. For example, a user may access a mobile banking application and/or financial institution application on a mobile device to submit or initiate a dispute request to credit bureaus and/or financial institutions. Other computing devices may also be used instead of or in addition to those described herein to submit dispute requests.

At step 203, dispute identification and resolution computing platform 110 may establish connections with data source systems 140, 150. For example, dispute identification and resolution computing platform 110 may establish second and third wireless data connections with data source systems 140, 150 to link dispute identification and resolution computing platform 110 with data source systems 140, 150. In some instances, dispute identification and resolution computing platform 110 may identify whether or not connections are already established with data source systems 140, 150. If connections are already established with data source systems 140, 150, dispute identification and resolution computing platform 110 might not re-establish the connections. If connections are not yet established with data source systems 140, 150, dispute identification and resolution computing platform 110 may establish the second and third wireless data connections as described above.

At step 204, dispute identification and resolution computing platform 110 may retrieve and receive, via the communication interface (e.g., communication interface 113) and while the second and third wireless data connections are established, data from source systems (e.g., data source systems 140, 150). For example, dispute identification and resolution computing platform 110 may retrieve historical data from a first data source system 140 (e.g., database system storing credit files for individuals at respective credit bureaus), and current credit report data from a second source system 150 (e.g., a new credit report). In some examples, dispute identification and resolution computing platform 110 may retrieve data from data source systems 140, 150 on a periodic and/or continuous basis so that duplicates and/or potential disputes may be identified promptly.

Referring to FIG. 2B, at step 205, based on retrieving the historical data and the current credit report data, dispute identification and resolution computing platform 110 may identify, using a DNA computing engine (e.g., DNA computing engine 112c), one or more potential reporting inaccuracies. For example, based on comparing the historical data and the current credit report data, dispute identification and resolution computing platform 110 may detect a discrepancy. In some examples, dispute identification and resolution computing platform 110 may identify a particular credit reporting agency (e.g., among several different credit reporting agencies) associated with the one or more potential reporting inaccuracies. For instance, dispute identification and resolution computing platform 110 may identify where erroneous or outdated information is being reported, so that a dispute may be raised to the appertaining reporting agency.

At step 206, dispute identification and resolution computing platform 110 may establish a connection with user computing device 160. For example, dispute identification and resolution computing platform 110 may establish a fourth wireless data connection with user computing device 160 to link dispute identification and resolution computing platform 110 with user computing device 160. In some instances, dispute identification and resolution computing platform 110 may identify whether or not a connection is already established with user computing device 160. If a connection is already established with user computing device 160, dispute identification and resolution computing platform 110 might not re-establish the connection. If a connection is not yet established with the user computing device 160, dispute identification and resolution computing platform 110 may establish the fourth wireless data connection as described above.

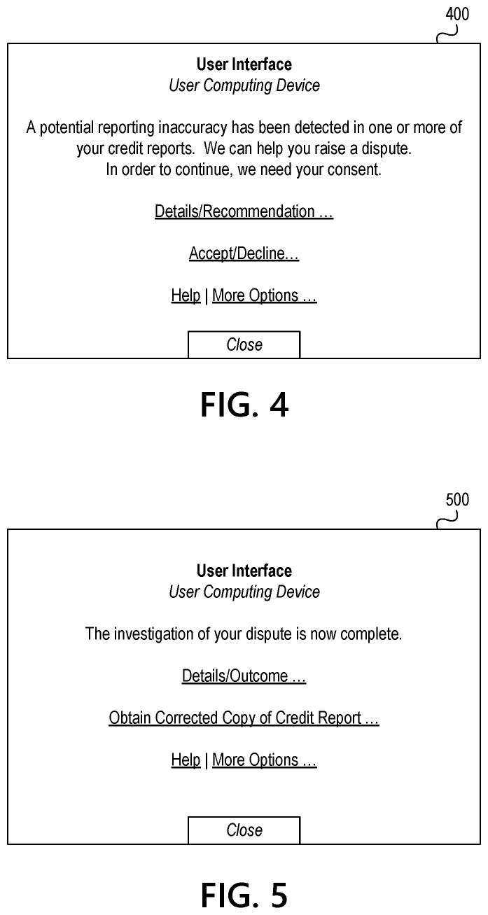

At step 207, dispute identification and resolution computing platform 110 may send, via the communication interface (e.g., communication interface 113) and while the fourth wireless data connection is established, to a computing device of a user (e.g., user computing device 160), a recommendation or other notification for automatically initiating a dispute request (e.g., raise a dispute that is identified by dispute identification and resolution computing platform 110) associated with the identified one or more potential reporting inaccuracies. For example, dispute identification and resolution computing platform 110 may cause the user computing device (e.g., user computing device 160) to display and/or otherwise present one or more graphical user interfaces similar to graphical user interface 400, which is illustrated in FIG. 4. As seen in FIG. 4, graphical user interface 400 may include text and/or other information associated with the recommendation (e.g., user computing device 160) (e.g., “A potential reporting inaccuracy has been detected in one or more of your credit reports. We can help you raise a dispute. In order to continue, we need your consent. [Details/Recommendation . . . ] [Accept/Decline . . . ]”). It will be appreciated that other and/or different notifications may also be provided.

Returning to FIG. 2B, at step 208, a user of the computing device (e.g., user computing device 160) may provide an input to accept or decline the recommendation for automatically initiating dispute resolution, and the computing device (e.g., user computing device 160) may send the user response to dispute identification and resolution computing platform 110.

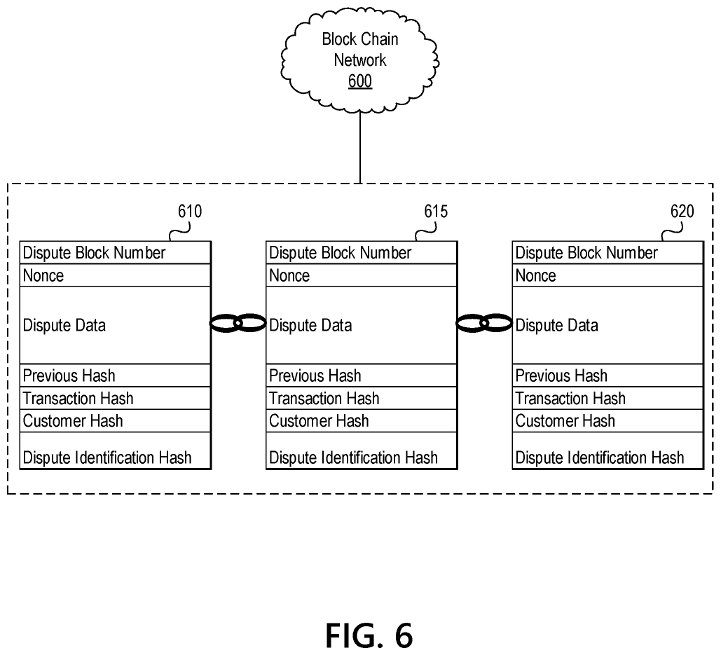

Referring to FIG. 2C, at step 209, dispute identification and resolution computing platform 110 may receive, via the communication interface (e.g., communication interface 113) and while the fourth wireless data connection is established, the user response. At step 210, based on receiving user approval or consent (e.g., input from the user accepting the recommendation), dispute identification and resolution computing platform 110 may initiate the dispute request. In initiating the dispute request, dispute identification and resolution computing platform 110 may create (e.g., via block chain module 112d) a block chain of dispute request information (e.g., for the individual user) based on at least aggregated information associated with past dispute requests. For instance, a user block chain ledger may be generated and/or updated. Each user may have a block chain associated with him or her. If one does not exist, upon initiation of the dispute request, a new block chain may be created for the user. As the dispute request is initiated, a record of dispute data may be written to the block chain (e.g., a new block may be created recording the dispute data). In some examples, user identifying information may be stored separately from dispute information, and the like. Accordingly, dispute information (e.g., account balance, payment history, and the like), and/or the like, may be provided to data analysts, may be used by one or more entities, or the like, to monitor credit usage behaviors, track payments, determine user behaviors (e.g., using machine learning), and/or the like. As shown in FIG. 6, a block chain ledger 610 of the block chain 610, 615, 620 may include a dispute block number, a nonce, dispute data, a cryptographic hash of the previous block (e.g., thus “chaining” the new block to the previous block), a transaction hash, a cryptographic hash of a user or customer identifier, a cryptographic hash of a corresponding dispute request, and/or the like. Each block chain (e.g., block chain 610, 615, 620) may operate in a block chain network (e.g., block chain network 600). Block chain network 600 may be a public block chain network (e.g., a decentralized peer-to-peer network), a private block chain network (e.g., where the ledger is controlled by a centralized authority), or other type of block chain network.

Returning to FIG. 2C, in some embodiments, at step 211, dispute identification and resolution computing platform 110 may detect and identify the automatically initiated dispute request as being a duplicate of a pending dispute request. For example, dispute identification and resolution computing platform 110 may detect that the dispute request initiated by the dispute identification and resolution computing platform 110 (e.g., second request at step 210) as being a duplicate of one already submitted and/or initiated by the user (e.g., first request at step 202 of FIG. 2A). For instance, a user may have already submitted an associated pending credit dispute (e.g., on their own, through mobile, online, or from a financial center, to credit bureaus and/or financial institutions, such as in step 202) having the same or similar dispute data.

At step 212, dispute identification and resolution computing platform 110 may consolidate the duplicate dispute requests by providing (e.g., forwarding) a single request to the appropriate credit bureau and/or financial institution.

Referring to FIG. 2D, at step 213, dispute identification and resolution computing platform 110 may calculate a probability value/score associated with prioritization (e.g., for implementing a priority queue) and identify parameters for adjustment. In some examples, dispute identification and resolution computing platform 110 may extract and analyze historical dispute data (e.g., from previous blocks of a block chain, using a quantum computing device such as a retrieval bot) and execute or run a causality based algorithm or causal discovery algorithm (e.g., using Naïve Bayes Classifier) to classify different sets of disputes. The causality based algorithm may identify the underlying cause of a behavior or event (e.g., discover causal relationships from data) and provide insights. For instance, the causality based algorithm may identify the cause of a particular dispute and provide insights or suggestions for changes. In some examples, dispute identification and resolution computing platform 110 may, based on the output of the causality based algorithm, determine a probability that one or more actual reporting inaccuracies exist (e.g., determine whether there is a likelihood of an inaccuracy) and/or identify one or more parameters for adjustment (e.g., determining which transaction parameter associated with a dispute request is to be changed, if any). In some examples, the probability may be compared to one or more thresholds to determine whether an inaccuracy is present and should be resolved. For instance, a probability above a threshold may indicate that an inaccuracy is present and should be resolved. Each parameter may indicate a type of change to be made (e.g., to a user account). In some instances, the identified one or more parameters may include an indication that no change is to be made.

At step 214, dispute identification and resolution computing platform 110 may retrieve a turnaround time for processing the dispute request (e.g., a remaining length of time, typically in days). In some examples, dispute identification and resolution computing platform 110 may consider the turnaround time in prioritizing dispute requests. For instance, dispute identification and resolution computing platform 110 may process cases (e.g., dispute requests) with a high likelihood of inaccuracy and short remaining turnaround time first. In some examples, the dispute identification and resolution computing platform 110 may consider one or more rules, regulations, service level agreements, or the like, setting time limits (e.g., a number of days within which a dispute must be resolved) on an amount of time to address a dispute. Accordingly, a number of days remaining in any time limit for a particular dispute may be considered when prioritizing disputes.

At step 215, dispute identification and resolution computing platform 110 may perform dispute resolution. For example, dispute identification and resolution computing platform 110 may update an account of the user based on the determined probability and the identified one or more parameters to resolve the dispute. In updating the account of the user, dispute identification and resolution computing platform 110 may (e.g., using a quantum bot or other quantum computing device), extract information associated with the account of the user (e.g., customer provided credit statements/documents), validate/match the information associated with the account of the user (e.g., from a system of records), and update/modify the account or credit file of the user (e.g., updating an outstanding balance, updating a payment history, removing incorrect information, and/or the like) to resolve the dispute.

At step 216, dispute identification and resolution computing platform 110 may send, via the communication interface (e.g., communication interface 113) and while the fourth wireless data connection is established, a notification to the user (e.g., user of user computing device 160) indicating a resolution of the dispute request (e.g., that one or more actual reporting inaccuracies have been resolved based on the modified parameters). For example, dispute identification and resolution computing platform 110 may cause the user computing device (e.g., user computing device 160) to display and/or otherwise present one or more graphical user interfaces similar to graphical user interface 500, which is illustrated in FIG. 5. As seen in FIG. 5, graphical user interface 500 may include text and/or other information notifying the user of the computing device (e.g., user computing device 160) about the outcome of a dispute request (e.g., “The investigation of your dispute is now complete. [Details/Outcome . . . ] [Obtain Corrected Copy of Credit Report . . . ]”). It will be appreciated that other and/or different notifications may also be provided.

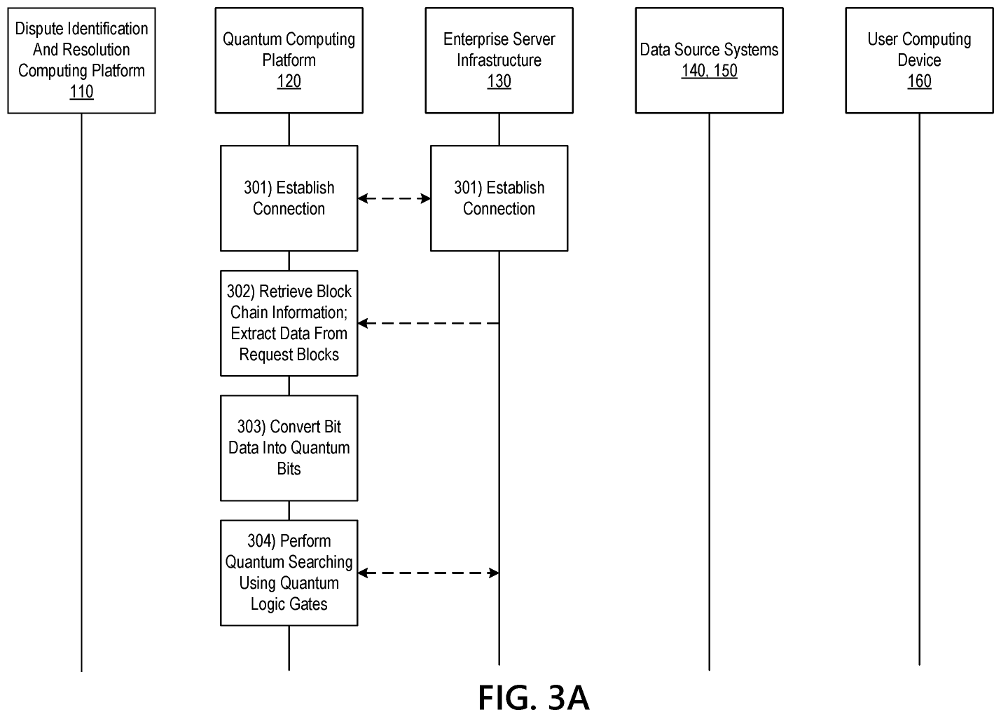

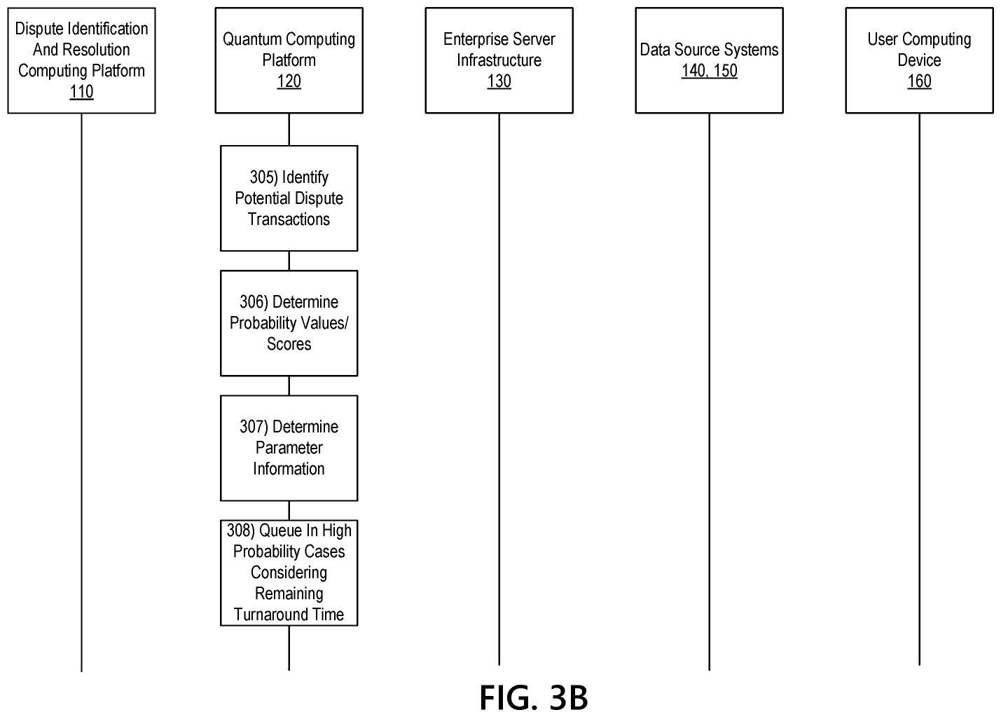

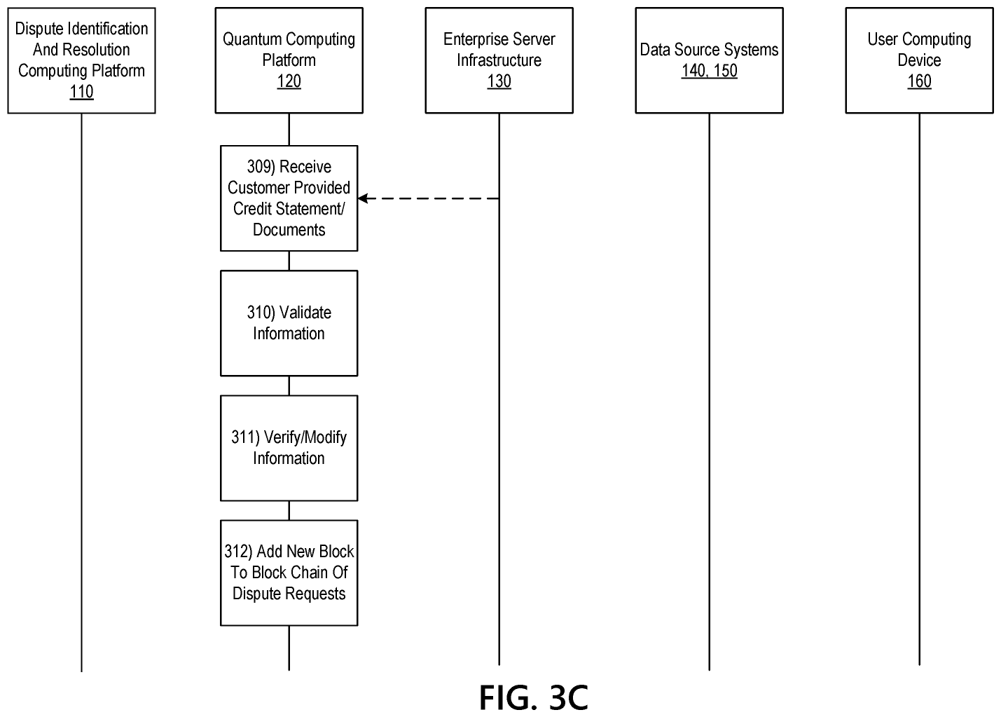

FIGS. 3A-3C depict another illustrative event sequence for cognitive identification of credit reporting disputes and dispute resolution using quantum computing in accordance with one or more example embodiments. Referring to FIG. 3A, at step 301, quantum computing platform 120 may establish a connection with enterprise server infrastructure 130. For example, quantum computing platform 120 may establish a wireless data connection with enterprise server infrastructure 130 to link quantum computing platform 120 with enterprise server infrastructure 130. In some instances, quantum computing platform 120 may identify whether or not a connection is already established with enterprise server infrastructure 130. If a connection is already established with enterprise server infrastructure 130, quantum computing platform 120 might not re-establish the connection. If a connection is not yet established with the enterprise server infrastructure 130, quantum computing platform 120 may establish the wireless data connection as described above.

Using a quantum computing device (e.g., a quantum computer that provides high speed computation and execution power to the quantum bots), at step 302, quantum computing platform 120 may retrieve/extract, via the communication interface (e.g., communication interface 123) and while the wireless data connection is established, dispute data from a block chain of dispute requests. As shown in FIG. 6, a block chain ledger 610 of the block chain 610, 615, 620 may include a dispute block number, a nonce, dispute data, a cryptographic hash of the previous block (e.g., thus “chaining” the new block to the previous block), a transaction hash, a cryptographic hash of a user or customer identifier, a cryptographic hash of a corresponding dispute request, and/or the like. Each block chain (e.g., block chain 610, 615, 620) may operate in a block chain network (e.g., block chain network 600). Block chain network 600 may be a public block chain network (e.g., a decentralized peer-to-peer network), a private block chain network (e.g., where the ledger is controlled by a centralized authority), or other type of block chain network.

Returning to FIG. 3A, at step 303, quantum computing platform 120 may convert (e.g., via qubit converter 122c) the retrieved dispute data (e.g., binary bit data) into quantum bits. For instance, in order to apply quantum search, the searched data is converted into quantum bits (qubits) upon which the quantum search can operate. A qubit may hold a “0”, a “1”, or a quantum superposition of these. Quantum computing platform 120 may process data stored as quantum bits and use quantum mechanics such as superposition and entanglement to perform computations.

At step 304, quantum computing platform 120 may perform, using quantum logic gates, quantum searching (e.g., via quantum search engine 122d) of the retrieved dispute data over a plurality of different databases or data sources (e.g., from different organizations or financial institutions). The quantum searching may be implemented using a plurality of quantum logic gates. The plurality of quantum logic gates may include a conservative logic gate (e.g., Fredkin gate), a fundamental quantum gate (e.g., Hadamard gate), and/or the like. In addition, the quantum searching may be further implemented using a refinement logic gate (e.g., for iteratively identifying the most relevant transactions for deferral). Referring to FIG. 3B, at step 305, quantum computing platform 120 may identify, based on the quantum searching, one or more potential dispute transactions.

At step 306, quantum computing platform 120 may determine, using the quantum computing device, probability values/scores for the one or more potential dispute transactions. At step 307, quantum computing platform 120 may determine respective parameters associated with the one or more potential dispute transactions. In some examples, quantum computing platform 120 may extract and analyze historical dispute data (e.g., from previous blocks of a block chain, using a quantum computing device such as a retrieval bot) and execute or run a causality based algorithm (e.g., using Naïve Bayes Classifier) to classify different sets of disputes. The causality based algorithm may identify the underlying cause of a behavior or event (e.g., discover causal relationships from data) and provide insights. For instance, the causality based algorithm may identify the cause of a particular dispute and provide insights or suggestions for changes. Based on the output of the causality based algorithm, quantum computing platform 120 may determine a probability that one or more actual reporting inaccuracies exist (e.g., determine whether there is a likelihood of an inaccuracy) and/or identify one or more parameters for adjustment (e.g., determining which transaction parameters associated with a dispute request is to be changed, if any). Each probability score may indicate a likelihood that a change associated with the one or more potential dispute transactions is to be made. Each parameter may indicate a type of change to be made (e.g., to a user account). In some instances, the identified one or more parameters may include an indication that no change is to be made.

At step 308, quantum computing platform 120 may prioritize the one or more potential dispute transactions in a queue based on the probability score for the one or more potential dispute transactions. For instance, quantum computing platform 120 may queue in high or highest probability cases first. In some examples, the one or more potential dispute transactions in the queue is further prioritized based on a remaining turnaround time (e.g., in days). For instance, quantum computing platform 120 may process cases (e.g., dispute requests) with a high likelihood of inaccuracy and short remaining turnaround time first.

Referring to FIG. 3C, at step 309, quantum computing platform 120 may extract user provided credit information (e.g., credit statements/documents). At step 310, quantum computing platform 120 may validate the user provided credit information against information from a system of records. At step 311, quantum computing platform 120 may automatically apply a change (e.g., modify information) associated with the one or more potential dispute transactions.

At step 312, quantum computing platform 120 may add (e.g., via block chain module 122e) a new block to the block chain of dispute requests (e.g., 610, 615, 620 in FIG. 6). Similar to block 610, for example, the new block may include a dispute block number, a nonce, dispute data, a cryptographic hash of the previous block (e.g., thus “chaining” the new block to the previous block), a transaction hash, a cryptographic hash of a user or customer identifier, a cryptographic hash of a corresponding dispute request, and/or the like.

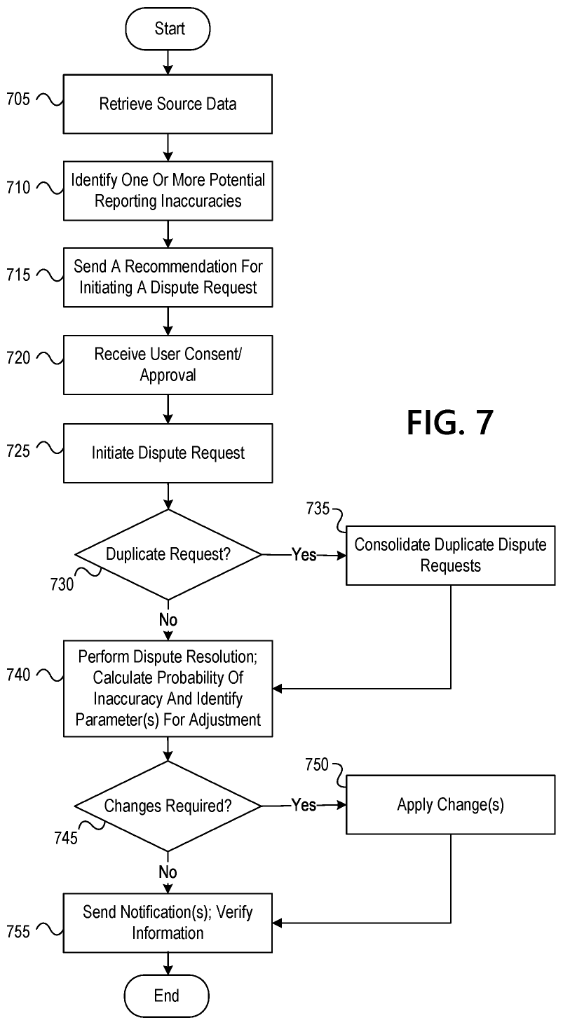

FIG. 7 depicts an illustrative method for using a DNA computing engine for cognitive identification of credit reporting disputes and dispute resolution in accordance with one or more example embodiments. Referring to FIG. 7, at step 705, a computing platform having at least one processor, a communication interface, and memory may retrieve, via the communication interface, historical data and current credit report data. At step 710, based on retrieving the historical data and the current credit report data, the computing platform may identify, using a DNA computing engine, one or more potential reporting inaccuracies. At step 715, the computing platform may send, via the communication interface, to a computing device of a user, a recommendation to initiate a dispute request associated with the identified one or more potential reporting inaccuracies. At step 720, the computing platform may receive, via the communication interface, from the computing device, input from the user accepting the recommendation. At step 725, the computing platform may initiate the dispute request. At step 730, the computing platform may determine whether the initiated dispute request is a duplicate of a pending dispute request. If the initiated dispute request is a duplicate of a pending dispute request, the computing platform may proceed to step 735. At step 735, the computing platform may consolidate the duplicate dispute requests and proceed to step 740. If the initiated dispute request is not a duplicate of a pending dispute request, the computing platform may proceed straight to step 740. At step 740, the computing platform may determine a probability that one or more actual reporting inaccuracies exist and identify one or more parameters for adjustment, where each parameter indicates a type of change to be made. At step 745, the computing platform may determine whether changes are to be made. If changes are to be made, the computing platform may proceed to step 750. At step 750, the computing platform may modify/update an account of the user based on the determined probability and the identified one or more parameters, and proceed to step 755. If no changes are to be made, the computing platform may proceed straight to step 755. At step 755, the computing platform may send, via the communication interface, a notification to the user indicating a resolution of the dispute request.

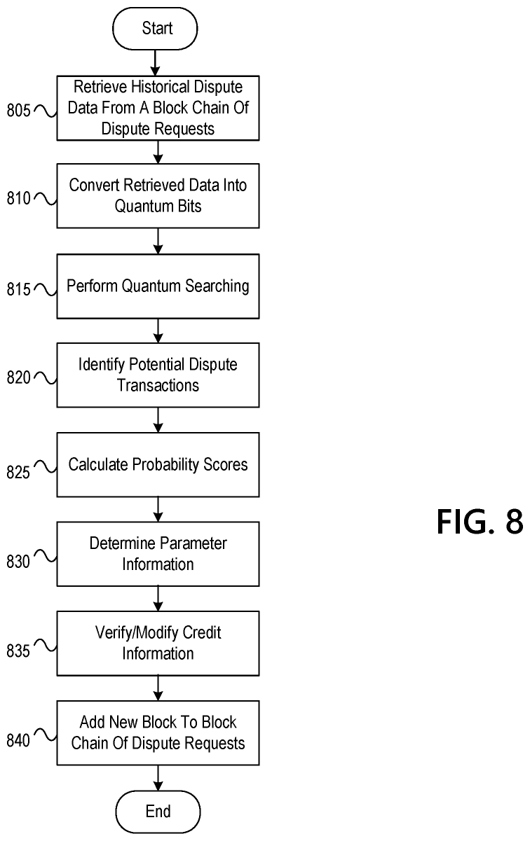

FIG. 8 depicts an illustrative method for using quantum bots (Qbots) and quantum logic gates to identify transactions for deferral in accordance with one or more example embodiments. Referring to FIG. 8, at step 805, a computing platform having at least one processor, a communication interface, and memory may retrieve dispute data from a block chain of dispute requests. At step 810, the computing platform may convert the retrieved dispute data into quantum bits for quantum searching. At step 815, the computing platform may perform, using quantum logic gates, quantum searching of the retrieved dispute data over a plurality of different databases. At step 820, the computing platform may identify, based on the quantum searching, one or more potential dispute transactions. At step 825, the computing platform may determine probability scores for the one or more potential dispute transactions, each probability score being based on a likelihood that a change associated with the one or more potential dispute transactions is to be made. At step 830, the computing platform may determine respective parameters associated with the one or more potential dispute transactions, where each parameter indicates a type of change to be made. At step 835, based on determining the probability scores and the respective parameters, the computing platform may verify and/or modify information associated with the one or more potential dispute transactions. At step 840, the computing platform may add a new block to the block chain of dispute requests.

In some examples, aspects described herein may be performed by multiple entities (e.g., financial institutions, credit bureaus, and the like) to share data, provide access to shared data, and the like. The data may be shared with permission of the users and the consortium may be used to ensure accuracy and completeness when addressing disputes.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to, using a quantum computing device:
retrieve, via the communication interface, dispute data from a block chain of dispute requests;
convert the retrieved dispute data into quantum bits for quantum searching;
perform, using quantum logic gates, quantum searching of the retrieved dispute data over a plurality of different databases;
identify, based on the quantum searching, one or more potential dispute transactions;
determine probability scores for the one or more potential dispute transactions, each probability score being based on a likelihood that a change associated with the one or more potential dispute transactions is to be made;
determine respective parameters associated with the one or more potential dispute transactions, wherein each parameter indicates a type of change to be made;
based on determining the probability scores and the respective parameters, apply a change associated with the one or more potential dispute transactions; and
add a new block to the block chain of dispute requests.

2. The computing platform of claim 1, wherein the memory stores additional computer-readable instructions that, when executed by the at least one processor, cause the computing platform to:
receive user provided credit information; and
validate the user provided credit information.

3. The computing platform of claim 1, wherein the memory stores additional computer-readable instructions that, when executed by the at least one processor, cause the computing platform to:
prioritize the one or more potential dispute transactions in a queue based on the probability score for the one or more potential dispute transactions.

4. The computing platform of claim 3, wherein the one or more potential dispute transactions in the queue is further prioritized based on a remaining turnaround time.

5. The computing platform of claim 1, wherein the quantum searching is implemented using a plurality of quantum logic gates.

6. The computing platform of claim 5, wherein the plurality of quantum logic gates comprise a conservative logic gate and a fundamental quantum gate.

7. The computing platform of claim 6, wherein the quantum searching is further implemented using a refinement logic gate.

8. The computing platform of claim 1, wherein each block of the block chain comprises a cryptographic hash of a corresponding dispute request.

9. The computing platform of claim 1, wherein each block of the block chain comprises a cryptographic hash of a user identifier.

10. The computing platform of claim 1, wherein the quantum computing device engages at least one of a plurality of quantum bots, each bot being configured to perform a different type of functionality.

11. A method, comprising:
at a computing platform comprising at least one processor, a communication interface, and memory:
retrieving, by the at least one processor, via the communication interface, dispute data from a block chain of dispute requests;
converting, by the at least one processor, the retrieved dispute data into quantum bits for quantum searching;
performing, by the at least one processor, using quantum logic gates, quantum searching of the retrieved dispute data over a plurality of different databases;
identifying, by the at least one processor, based on the quantum searching, one or more potential dispute transactions;
determining, by the at least one processor, probability scores for the one or more potential dispute transactions, each probability score being based on a likelihood that a change associated with the one or more potential dispute transactions is to be made;
determining, by the at least one processor, respective parameters associated with the one or more potential dispute transactions, wherein each parameter indicates a type of change to be made;
based on the probability scores and the respective parameters, applying, by the at least one processor, a change associated with the one or more potential dispute transactions; and
adding, by the at least one processor, a new block to the block chain of dispute requests.

12. The method of claim 11, further comprising:
receiving, by the at least one processor, user provided credit information; and
validating, by the at least one processor, the user provided credit information.

13. The method of claim 11, further comprising:
prioritizing, by the at least one processor, the one or more potential dispute transactions in a queue based on the probability score for the one or more potential dispute transactions.

14. The method of claim 13, wherein the one or more potential dispute transactions in the queue is further prioritized based on a remaining turnaround time.

15. The method of claim 11, wherein the quantum searching is implemented using a plurality of quantum logic gates.

16. The method of claim 15, wherein the plurality of quantum logic gates comprise a conservative logic gate and a fundamental quantum gate.

17. The method of claim 16, wherein the quantum searching is further implemented using a refinement logic gate.

18. The method of claim 11, wherein each block of the block chain comprises a cryptographic hash of a corresponding dispute request and a cryptographic hash of a user identifier.

19. The method of claim 11, wherein the quantum computing device engages at least one of a plurality of quantum bots, each bot being configured to perform a different type of functionality.

20. One or more non-transitory computer-readable media storing instructions that, when executed by a computing platform comprising at least one processor, a communication interface, and memory, cause the computing platform to:
retrieve, via the communication interface, dispute data from a block chain of dispute requests;
convert the retrieved dispute data into quantum bits for quantum searching;
perform, using quantum logic gates, quantum searching of the retrieved dispute data over a plurality of different databases;
identify, based on the quantum searching, one or more potential dispute transactions;
determine probability scores for the one or more potential dispute transactions, each probability score being based on a likelihood that a change associated with the one or more potential dispute transactions is to be made;
determine respective parameters associated with the one or more potential dispute transactions, wherein each parameter indicates a type of change to be made;
based on determining the probability scores and the respective parameters, apply a change associated with the one or more potential dispute transactions; and
add a new block to the block chain of dispute requests.
